(19) United States
(12) Patent Application Publication
(10) Pub. No.: US 2004/0260605 A1
(43) Pub. Date: Dec. 23, 2004

(54) Method for promoting entertainment event attendance to networked users using demographic profile data

(75) Inventors: Dale F. McIntyre, Honeoye Falls, NY (US); John R. Fredlund, Rochester, NY (US); David L. Patton, Webster, NY (US); Michael E. McCrackan, Rochester, NY (US); Carlo V. Hume, Fairport, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/463,353

(22) Filed: Jun. 17, 2003

(51) Int. Cl. G06F 17/60

(52) U.S. Cl. 705/14

(57) ABSTRACT

A method for broadcasting a promotional message (304) for an entertainment event, where the promotional message (304) is directed to recipients having at least one predetermined attribute. A database (314) is queried by an exhibitor (320) to obtain a network address for each of a plurality of users having said at least one predetermined attribute. The promotional message (304) for the event is then broadcast to provide an offer to these addresses. Upon receipt of an acceptance response to the offer, a token (306), such as a pass or coupon, is provided to the responding recipient to be presented by the user for admission.

### FIELD OF THE INVENTION

This invention generally relates to on-line promotion and advertising and more particularly relates to a method for using demographic profile data about networked users to promote attendance at entertainment events.

### BACKGROUND OF THE INVENTION

Demographic metrics have been used as a basis for targeting entertainment, advertising, and promotional material to an audience group. Among numerous examples, U.S. Pat. No. 5,758,257 (Herz et al.) discloses a method for using customer profile data to tailor the material made available to customers of cable television; U.S. Patent Application Publication 2002/0156677 A1 (Peters et al.) discloses a method and system for providing targeted advertising in public places, based on demographic and preference information obtained from digital devices such as Personal Digital Assistants (PDAs) carried by individuals; U.S. Pat. No. 5,155,591 (Wachob) discloses providing demographically targeted commercial advertisements to television viewers, based on demographic and preference profile data for each viewer site; and U.S. Pat. No. 6,128,663 (Thomas) discloses a method for providing targeted Internet content to a requestor based on demographic and preference information.

Demographic metrics have also been used by motion picture producers and distributors to obtain raw feedback data on overall audience appeal and on the relative degree of commercial success or failure of a motion picture for its target audience. It can be appreciated that there would be considerable potential value in adapting motion picture or other event entertainment content to a particular audience, based on demographic metrics, and in using commercially available demographic data for attracting an audience for an entertainment event, such as a feature presentation, at particular times and viewing locations.

Commonly assigned U.S. patent application Ser. No. 10/402,084, entitled “Method for Adapting Digital Cinema Content to Audience Metrics” and filed 28 Mar. 2003 in the names of David L. Patton, Dale McIntyre, John R. Fredlund, Michael McCrackan, Carlo Hume, and Arthur J. Cosgrove, is directed to making more effective use of product placement and other advertising and promotional opportunities, based on demographic and other data obtained about the audience for each showing of a digital motion picture. For the methods disclosed therein, demographics and other audience metrics are available for profiling the audience that has arrived at the theater and can be obtained before or during a showing of the motion picture and used to influence the content of the motion picture presentation, including any advertising and promotional content. In this way, demographic and other metrics about the audience can be used in order to provide both advertisement and entertainment that is well suited to the audience that is seated in the theater.

While profiling the audience can have significant value for increasing the effectiveness of advertising and product placement opportunities, even further value could be obtained by attracting an audience that has a specific set of desirable demographic characteristics. Admittedly, current techniques for advertising a movie or other entertainment event itself, whether on TV or radio or in newspapers or magazines, can have a very low success rate, considering the number of people exposed to the advertisement. By and large, these existing techniques do not provide suitable ways for attracting a particular type of audience to a particular event, such as a movie showing at a particular time. Thus, movie theaters, for example, are characteristically in a “reactive” mode with respect to audience demographics. Rather than attempt to attract a certain type of audience for a specific showing, theaters generally open their doors and hope to fill the seats with whatever audience shows up. Certainly, there are factors such as time of day that determine the likely demographic composition of an audience. However, techniques for “filling the house” of a specific theater at a specific showing with an audience having a specific profile have not been successful, except where a substantial lead time is allowed in order to provide suitable advertising that targets specific groups or organizations.

As just one example, recent Civil War movies are of special interest to individuals and groups who participate in re-enactment activities. Conventionally, attracting an audience largely consisting of such “re-enactors” to a specific showing could be done, but would require targeted publicity and advertising, including contacting specific groups and organizations, and could require advance notice of several days.

Using conventional advertising media, local theaters and entertainment facilities have some tools for boosting audience attendance at the local level. However, there would be significant advantages for individual theaters, concert promoters, and other event organizers to have tools and techniques that attract audience members in other ways.

Accompanying the rapid growth in Internet use are ever more sophisticated techniques for gathering data about the Internet user at a particular address. Search engines, for example, attempt to profile a user based on queries made and Web sites visited. On-line advertising can then be selectively delivered to specific individuals who have made on-line inquiries about various subjects. America On-line (AOL), for example, maintains profile information on individual subscribers whom it serves as an Internet Service Provider (ISP), storing various demographic data and information about personal characteristics and interests for each subscribing user. On-line advertisers can take advantage of this profile information for promotion of various products and services, including motion pictures. However, while motion pictures and other entertainment events have been promoted using broadcast messages and mechanisms such as Internet browser pop-up windows, it can be appreciated that there would be value in providing a more carefully targeted promotion utilizing on-line profile data for promoting motion picture showings, concerts, sporting events, or other performances, at specific times and locations. Such promotional broadcasts can be closely targeted to user demographic profiles or to other user attributes, allowing entertainment providers to take advantage of the capabilities for both attracting an audience exhibiting a certain demographic profile and providing content that is suited specifically to that audience. In the example case given above, information available on-line could identify participants who enjoy re-enactment events and might be willing to attend a specific showing of a motion picture based on that interest. The speed of Internet message delivery could also be tapped, allowing entertainment providers to broadcast promotions within a few hours of an event.

An example of one promotional utility utilizing network tools is given in U.S. Patent Application Publication 2002/0087407 entitled “A Method and Apparatus for Distributing Tickets Over a Wide Area Network” in the name of John Mazzocco, which discloses an on-line contest suitable for a networked service provider such as Oregon-based Poundhouse (http://www.poundhouse.com). In the method disclosed in Publication 2002/0087407, the service provider runs a contest to distribute giveaway tickets to its members, allowing an event exhibitor to “paper the house” with free seats. With this method, an event exhibitor effectively uses this third-party contest service to fill up unsold seats for an event without compromising the ticket price and without publicly disclosing the actual number of giveaway tickets. Limited to member subscribers, the system disclosed in Publication 2002/0087407 provides a method for increasing audience size and helps to generate interest in an entertainment event by running a contest. However, seats awarded using this method are provided for free, with hopes that auxiliary purchases of “winning” audience members, such as for refreshments and souvenirs, will compensate for lost ticket sales. The service providing the contest charges a fee to the exhibitor, so that the giveaway tickets not only represent lost profits but, instead, are a cost item. It may be difficult to convince an event exhibitor that this strategy makes sense. For example, providing too many free seats to events using such a utility could backfire over time, effectively losing a percentage of paying audience members who opt to enter a contest giving them a good chance for free tickets rather than to pay inflated prices for concerts, motion picture performances, stage plays, operas, and other entertainment events. Many users could delay purchasing a ticket until the last minute, in the hopes of winning free admission; disappointment at not winning may actually deter someone from subsequently purchasing a ticket. Using only Internet and email tools, the method disclosed in Publication 2002/0087407 is limited in its potential to reach the larger base of networked users, such as those who utilize cellphone and networked Personal Digital Assistant (PDA) tools. A subtle shortcoming of this method relates to its “paperless” nature; the winner is notified and simply reports, with driver's license or other identification, to a ticket booth of the vendor who is provided with a list of winner names. The winner does not have the confidence provided by some tangible evidence that entitles enjoyment of the promotional terms. Thus, while the method disclosed in Publication 2002/0087407 may have short-term advantages for building audience size, this method has profit-related drawbacks and hazards some untested assumptions that may limit its value as a promotional utility for attracting an audience from networked users.

Thus it can be seen that there would be particular advantages in a method for on-line promotion of entertainment events using demographic and geographic data about networked users, wherein the method provides a user with a token that is redeemable for a reduced admission price or other favorable offer.

### SUMMARY OF THE INVENTION

It is an object of the present invention to provide a method for broadcasting a promotional message for an entertainment event, where the promotional message is directed to recipients having at least one predetermined attribute.

The present invention is directed to overcoming one or more of the problems set forth above. Briefly summarized, according to one aspect of the present invention, a method for broadcasting a promotional message for an entertainment event, where the promotional message is directed to recipients having at least one predetermined attribute, comprises (a) obtaining a network address for each of a plurality of recipients having at least one predetermined attribute; (b) transmitting the promotional message for the entertainment event to each of the network addresses wherein the promotional message comprises an offer; (c) receiving an acceptance response to the offer from a responding recipient at at least one of said network addresses; and (d) providing to the responding recipient at at least one of said network addresses, a token to be presented for admission to the entertainment event according to the offer.

A feature of the present invention is the use of a network connection for sending a promotional message for a specific showing of an entertainment event such as a motion picture film showing, a concert, opera, celebrity appearance, stage theater presentation, sports event, circus, ice show, museum exhibition, live radio presentation, a radio show taping, or live TV filming, for example.

It is an advantage of the present invention that it allows a local theater to send an on-line promotional message to local recipients who are networked in any of a number of different ways, including subscribers to Internet, cellphone, or networked PDA services, for example.

It is a further advantage of the present invention that it provides a method for promoting a specific performance of an entertainment event, targeted for specific audience demographics or other audience metrics.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic block diagram showing basic structures and relationships as employed in one embodiment of the present invention;

FIG. 2 is an example screen message that displays for promotion of an entertainment event in an on-line embodiment of the present invention;

FIG. 3 is a sample coupon used in an embodiment of the present invention; and,

FIG. 4 is a flow chart showing the procedural sequence executed by an entertainment provider using the method of the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

On-Line Promotion for Motion Picture Showing

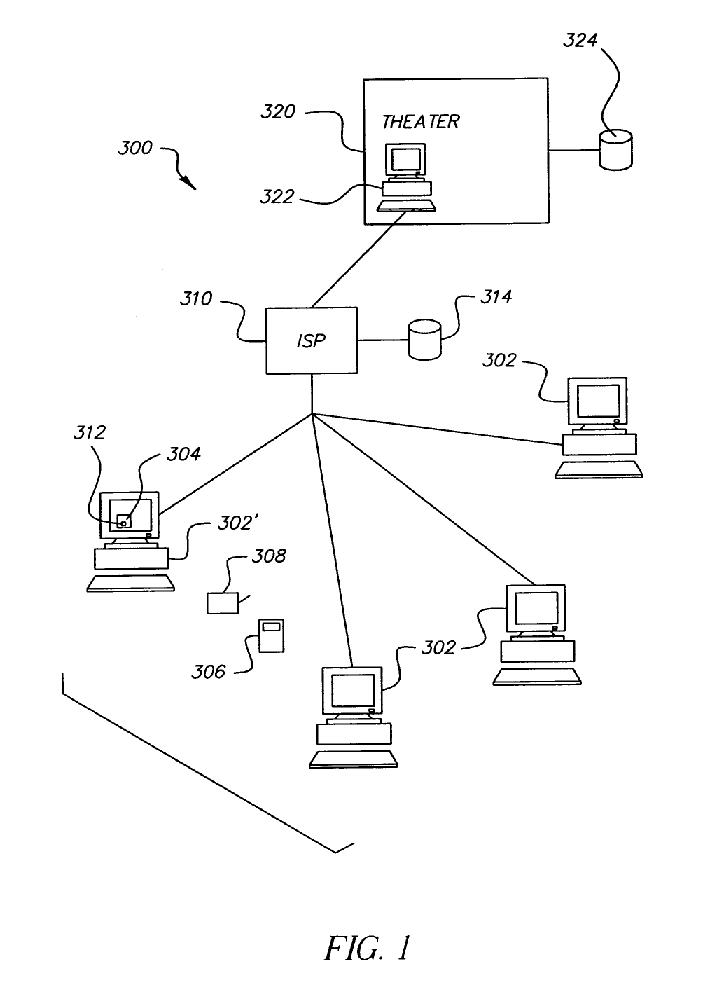

Referring to FIG. 1, there is shown a block diagram of a basic embodiment of the present invention with a network 300 by which an exhibitor 320, such as a motion picture theater, broadcasts its on-line promotion to one or more subscriber workstations 302 of an Internet Service Provider (ISP) 310. In order to provide an on-line promotion, a networked workstation 322 sends a query for profile information about subscribers of ISP 310. The query may go to an event provider database 324; however, it is more likely that the query be directed to an ISP database 314 maintained by ISP 310 or by some other networked service with profile data about individual subscribers. By way of example, and not by way of limitation, profile data stored on ISP database 314 for each subscriber may include the following:

(a) age;

(b) sex;

(c) hobbies;

(d) pets;

(e) sports interests;

(f) occupation;

(g) marital status;

(h) household income level;

(i) information on recent purchases by credit card;

(j) phone number; and,

(k) address

As just one example, the query from networked workstation 322 might include the following criteria:

(i) age: 16-45

(ii) sex: female

(iii) address: zip codes beginning with 345

In response to the query, an email address, cell phone number, networked PDA address, network moniker or nickname (such as a screen name available to Instant Message users), or other electronic network addresses for each subscriber meeting these criteria is provided from ISP database 314. These addresses are then used by local exhibitor 320 to broadcast a promotional message about an entertainment event, such as showing of a motion picture, for example. Using this type of query, an individual exhibitor 320 can quickly make contact with a potentially large prospective audience and attempt to attract that audience for a specific showing of a motion picture film or other entertainment event using a coupon or other promotional token. Exhibitor 320 can target specific audience segments and broadcast a suitable advertising message customized for each segment.

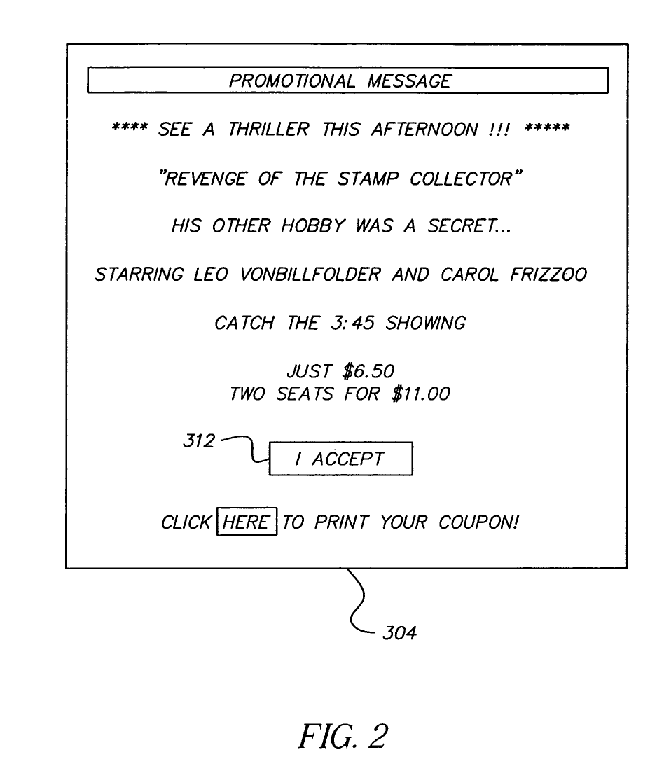

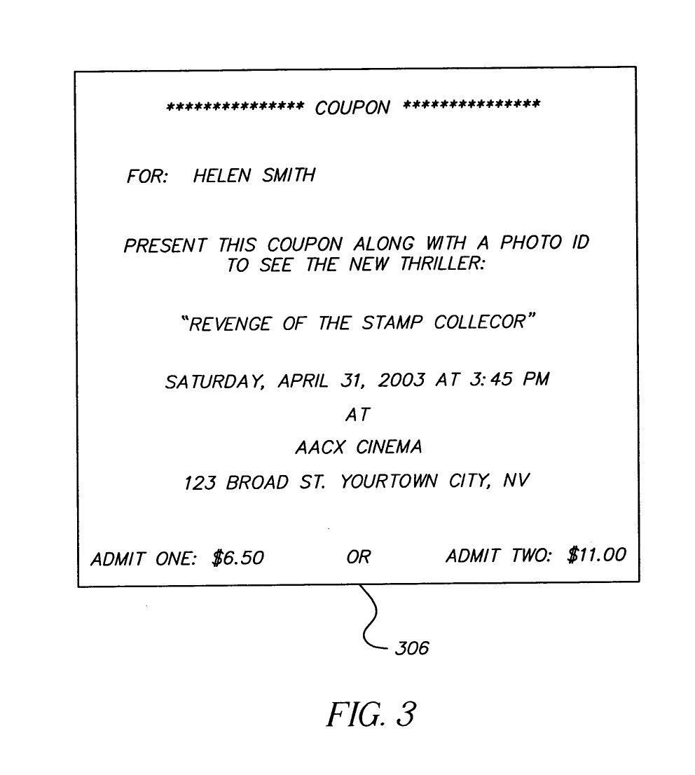

Still referring to FIG. 1, querying ISP database 314 has identified a selected subscriber workstation 302′ for a subscriber meeting profile criteria. A promotional message 304 is sent to selected subscriber workstation 302′, displayed on a computer screen, as is shown in the example promotional message 304 of FIG. 2. The broadcast message typically includes some type of incentive, such as reduced ticket price, for example. Upon acceptance of the offer, a token 306 is provided in some form, where token 306 is intended to be presented for admission to the showing of the motion picture or other entertainment event being promoted or is required for ticket purchase under the terms of the promotion embodied in the broadcast message. In the embodiment shown in FIG. 3, token 306 is a coupon, voucher, or pass to be printed at printer 308, which may be connected to selected subscriber workstation 302. Token 306 could alternately be a password or codeword, or some other unique identifier for the responding recipient, to be mentioned at the time of ticket purchase or entered at a terminal or kiosk at the event or ticket purchase location, for example. For cell phone or PDA subscribers, token 306 could be provided as a message intended for storage and replay at the site of ticket purchase, including a message transferred using a wireless transmission from the portable device. Token 306 could be provided for use in conjunction with an account card such as a “preferred customer” identification card or related document, similar to cards provided by various grocery and drug store chains for obtaining discounts. Thus, for example, by presenting and scanning or “swiping” an account card upon acceptance, a regular, loyal customer could qualify for the promotional offer. By using token 306, the method of the present invention provides the user who takes advantage of the promotion with an item of perceived value to be brought to the ticket purchase site. Particularly with coupon or voucher printing, this method provides a tangible item having a perceived value as token 306.

The present invention could be used in conjunction with messaging tools such as AOL's Instant Messenger (IM). Using this type of utility, a message can be broadcast only to users who are on-line at a particular time. For example, exhibitor 320 may want to boost audience attendance for a 6:30 PM motion picture showing, targeting adults age 55 or over. Using Instant Messenger and a related ISP database 314, exhibitor 320 can selectively advertise the 6:30 PM showing to network users within this age range who go on-line any time that afternoon. This arrangement may be preferred, for example, over sending email to many users who may receive the message too late. Promotional techniques directed to impulse buying may also be effective when used in conjunction with IM and similar real-time messaging utilities.

The embodiment of FIG. 1 admits a number of variations within the scope of the present invention. For example, network connection may take any of a number of forms as an alternative to Internet use. Promotional message 304 could alternately be provided over a cellular phone network, communicating with individual subscribers having a desired demographic profile. The message provided over such a network could be a text data message for display, such as on a handheld personal computer or Personal Digital Assistant (PDA), for example. Alternately, promotional message 304 could be an audio message, delivered to a message storage location provided to each cellular phone subscriber. As yet another alternative, promotional message 304 could be an audio-visual message such as a film trailer, for example. A film trailer provided in this manner can be designed to play on a handheld display or PDA that provides audio output. As yet another example, a Short Message Service (SMS), part of the GSM (Global System for Mobile Communications) Phase 1 standard, would allow a text message to be received over a cellphone and stored for replay at the event site.

Sequence of Steps

Some type of acceptance action from the purchaser would be required in order to provide or to validate token 306. In the example of FIG. 2, the recipient of promotional message 304 indicates acceptance by clicking on acceptance button 312. When the acceptance command is processed and approved, a command for printing a coupon would then be enabled. Optionally, a code or password might be provided following acceptance. As yet another alternative, a recipient may be prompted to bring some type of identification card or preferred customer card as token 306.

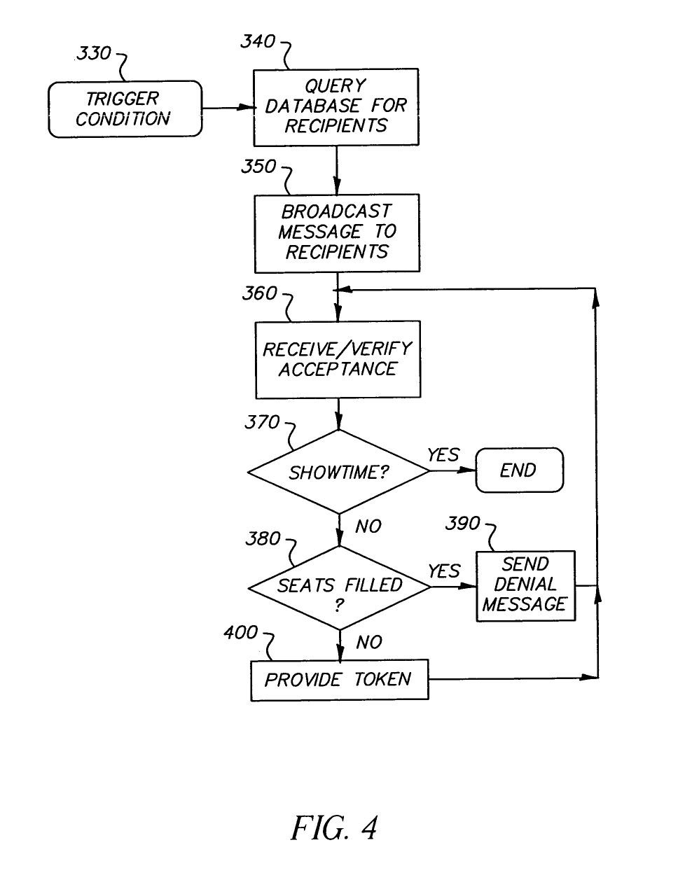

The flowchart of FIG. 4, depicts the procedural steps for event promotion that provide token 306. These steps would be carried out by software at networked workstation 322 (FIG. 1) or at some other suitable control system. A trigger condition 330 begins the process. Trigger condition 330 may be a decision by event provider management to initiate a promotion. In one embodiment, trigger condition 330 is automatic, based on advance ticket sales at some time interval preceding the event. For example, trigger condition 330 may be automatically met when ticket sales are below 30% seating capacity, 24 hours from showtime. Different trigger conditions could apply for the same promotional offering, such as using staggered sales percentages as showtime approaches, for example.

In a query step 340, a database query is executed to obtain a listing of electronic addresses for contacting profiled users eligible for the promotion. Query step 340 could be adaptive, based on different trigger conditions 330. For example, with respect to geographical criteria used to determine which recipients receive the promotional broadcast message, a distance radius threshold would be decreased as showtime nears. As a result of query step 340, a listing of recipients is obtained. In a subsequent broadcast step 350, promotional message 304 is sent to these recipients.

As the flowchart of FIG. 4 shows, once broadcast step 350 is executed, a looping sequence is performed. In a repeated receive/verify acceptance step 360, acceptance responses from recipients are obtained. With reference to FIG. 1, for example, an acceptance response would be transmitted back to networked workstation 322 at exhibitor 320 when the recipient at selected subscriber workstation 302′ clicks on acceptance button 312. In receive/verify acceptance step 360, this acceptance response is logged and, where applicable, account data for the recipient is updated. The receiving system performs a time check step 370 to determine if the acceptance response is timely and can be serviced. At showtime, for example, the promotional offer may be terminated or extended for a later showing, if appropriate, with the recipient receiving an appropriate message. The receiving system also performs a seating capacity check step 380 to determine if seats are still available. Generally, promotional message 304 is broadcast to as many recipients as meet the criteria used in query step 340, in excess of the number of unsold seats that are actually available. Acceptance responses can then be handled in a first-come, first-served manner, so that prompt responses are more likely to be fulfilled by exhibitor 320. In the event that seating capacity is reached, a message is sent back to the responding recipient at selected subscriber workstation 302′ in a denial message step 390. This message would indicate that the promotional offer is no longer available under the original terms. This message may include an alternative promotional offer and/or may provide some other benefit, such as a coupon for a general discount at a future event, for example. If seating capacity check step 380 shows that seats are available, a token providing step 400 is executed. In this step, token 306 is provided in some form. This could be performed in a number of ways, such as by enabling the printing of a paper coupon, by providing a codeword or password to be presented at the event site, by instructing the recipient to produce a preferred customer card or other identification at the event site, or by downloading a message to a portable computing or communications device for replay at the event site.

Still referring to FIG. 4, the looping action of these procedural steps continues until cancelled or otherwise terminated, either at showtime or at some other appropriate point. Account information obtained for the networked recipient can be used for billing purposes. Billing itself would be performed when token 306 is produced by the recipient at the event site. Possible payment methods for a promotion include the option of billing the user's network account, such as a customer's AOL account or other ISP account or cell phone account, for example. Payment using this type of mechanism allows a user to respond spontaneously to a promotional offer. For example, a user could present token 306 and have payment automatically billed to the ISP subscriber account or credit card. Where the token comprises a unique identifier for the responding recipient, the unique identifier could be used to record a data entry in a customer account database. Payment would not normally be made at the time the recipient sends the acceptance response; the transaction would be completed upon producing token 306. In this way, the method of the present invention provides a type of “reservation” system for reserving a seat at an entertainment event.

Options for Profiling Potential Recipients

Several types of profile criteria could be used for selecting the set of recipients who are contacted with promotional message 304. In addition to information from ISP database 314 or event provider database 324, geographical location could be used as profile criteria for on-line computer users. Other tools allow more sophisticated techniques for locating potential audience members. For example, it is possible to locate each cellphone system subscriber who is currently within a predetermined radius of a motion picture exhibitor or other entertainment event location. Such a predetermined radius would be calculated with respect to travel distance needed for reaching the entertainment event within a given time. Methods such as triangulation could be used to identify cellphone or PDA users within such a predetermined radius distance, for example. Multiple messages can be sent at different times, with the broadcast radius distance suitably adjusted for travel distance relative to the starting time for the event. Global Positioning System (GPS) facilities could be used in order to identify nearby portable communication devices, such as PDAs or cellphones, as recipients.

In one embodiment, optional event provider database 324 has a different function from that provided by ISP database 314. Event provider database 324 is used to store user response information for a promotion, maintaining records that can be used to offer premiums, coupons, or other benefits for customers who have responded to promotional messages one or more times to attend special performances. Each customer would have a unique customer ID for maintaining account records so that data entries are made to the appropriate account to record attendance, incentive credits, and other information. Other types of commercial database (not shown in FIG. 1) could alternately be employed, such as a database serving an Internet search utility, for example.

As noted above, event provider database 324 could provide profile information about holders of a preferred customer card or tag that is intended to identify repeat customers of a particular exhibitor. This option could automate tracking and identity of customers who respond to promotional message 304 and who are entitled to a discount or other special offer. The preferred customer card that is presented at the time of showing would serve as the necessary token for entry under the special terms of the promotion.

It can be seen that the method of the present invention for using demographic data to draw an audience to a motion picture showing can be used in conjunction with methods that adapt digital motion picture content to suit the demographics of that same audience. Unlike other advertising and promotional media, the use of a network infrastructure is particularly well suited for local use, allowing an individual exhibitor or other event provider to customize its promotional offerings to the viewing public. By working to attract and please a targeted audience, entertainment event providers can thus enjoy opportunities for enhanced profitability and for building and maintaining a loyal customer base.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. As one variation of the embodiment described herein, an incentive system can be adopted to encourage customers to inform others of entertainment events. In this incentive system, promotional message 304 containing token 306 can be forwarded from one subscriber workstation 302 to a new customer, who may or may not be a subscriber to the same ISP 310 or other network. When promotional message 304 is forwarded and/or when token 306 is redeemed by the new customer, the existing customer receives an incentive. This incentive may be, for example, a reduced price on a future event or on a refreshment or souvenir item, “bonus points” granted to a preferred customer account, or other benefit. To facilitate this incentive system, an optional command button labeled “Forward to a Friend” (not shown) could be added to promotional message 304.

Thus, what is provided is a method for using demographic profile data about networked users to promote attendance for entertainment events.

### PARTS LIST

300. Network

302. Subscriber workstation

302′. Selected subscriber workstation

304. Promotional message

306. Token

308. Printer

310. Internet Service Provider

312. Accept button

314. ISP database

320. Exhibitor

322. Networked workstation

324. Event provider database

330. Trigger condition

340. Query step

350. Broadcast step

360. Receive/verify acceptance step

370. Time check step

380. Seating capacity check step

390. Denial message step

400. Token providing step

What is claimed is:

1. A method for broadcasting a promotional message for an entertainment event, said promotional message directed to recipients having at least one predetermined attribute, the method comprising:
(a) obtaining a network address for each of a plurality of recipients having said at least one predetermined attribute;
(b) transmitting said promotional message for the entertainment event to each of said network addresses, wherein the promotional message comprises an offer;
(c) receiving an acceptance response to said offer from a responding recipient at at least one of said network addresses; and
(d) providing to said responding recipient at said at least one of said network addresses, a token to be presented for admission to the entertainment event according to said offer.

2. A method for broadcasting a promotional message according to claim 1 wherein the step of obtaining a network address comprises the step of querying a database.

3. A method for broadcasting a promotional message according to claim 1 further comprising the step of executing an account transaction upon admission to the entertainment event, according to said offer.

4. A method for broadcasting a promotional message according to claim 3 wherein said account transaction employs a customer account card for said responding recipient.

5. A method for broadcasting a promotional message according to claim 1 wherein steps (a)-(d) are automatically initiated according to an advance ticket sales count.

6. A method for broadcasting a promotional message according to claim 1 wherein said token is a password for admission.

7. A method for broadcasting a promotional message according to claim 1 wherein said token is a coupon for printing by said responding recipient.

8. A method for broadcasting a promotional message according to claim 1 wherein the step of providing a token comprises the step of enabling a printing operation at a workstation at said at least one of said network addresses.

9. A method for broadcasting a promotional message according to claim 2 wherein said database is accessed by an Internet Service Provider.

10. A method for broadcasting a promotional message according to claim 1 wherein the step of obtaining a network address comprises the step of obtaining an email address.

11. A method for broadcasting a promotional message according to claim 1 wherein the step of obtaining a network address comprises the step of obtaining an IP address.

12. A method for broadcasting a promotional message according to claim 1 wherein the step of obtaining a network address comprises the step of obtaining a cellphone number.

13. A method for broadcasting a promotional message according to claim 1 wherein the step of obtaining a network address comprises the step of obtaining a unique moniker.

14. A method for broadcasting a promotional message according to claim 1 wherein said at least one predetermined attribute is taken from the set consisting of age, sex, occupation, marital status, geographic location, and income level.

15. A method for broadcasting a promotional message according to claim 1 wherein the entertainment event is presented at an event site and said at least one predetermined attribute comprises a travel distance to the event site.

16. A method for broadcasting a promotional message according to claim 1 wherein the step of transmitting said promotional message comprises the step of calculating a travel time relative to a starting time for the entertainment event.

17. A method for broadcasting a promotional message according to claim 16 wherein the step of transmitting said promotional message comprises the step of limiting the transmission to said plurality of recipients who are within a predetermined said travel time.

18. A method for broadcasting a promotional message according to claim 15 wherein triangulation is used to compute said travel distance.

19. A method for broadcasting a promotional message according to claim 1 further comprising the step of billing an account of said responding recipient.

20. A method for broadcasting a promotional message according to claim 19 wherein said token comprises a customer account card.

21. A method for broadcasting a promotional message according to claim 1 further comprising the step of billing an internet service provider (ISP) subscriber account for said responding recipient.

22. A method for broadcasting a promotional message according to claim 2 wherein said database is maintained by an exhibitor.

23. A method for broadcasting a promotional message according to claim 1 further comprising the step of providing customer account cards for an entertainment event exhibitor.

24. A method for broadcasting a promotional message according to claim 1 wherein said offer comprises a discounted admission price.

25. A method for broadcasting a promotional message according to claim 1 wherein the entertainment event is selected from a group consisting of a motion picture film showing, a concert, an opera, a celebrity appearance, a stage theater presentation, a sports event, a circus, an ice show, a museum exhibition, a live radio presentation, a radio show taping, and a live TV filming.

26. A method for broadcasting a promotional message according to claim 1 wherein said token comprises a unique identifier for said responding recipient.

27. A method for broadcasting a promotional message according to claim 26 wherein said unique identifier is used to record a data entry in a customer account database.

28. A method for broadcasting a promotional message according to claim 1 wherein the step of obtaining a network address further comprises the step of determining which of said recipients are currently on-line.

29. A method for broadcasting a promotional message according to claim 1 further comprising the step of receiving a wireless transmission as said token.

30. A method for broadcasting a promotional message for an entertainment event, said promotional message directed to recipients having at least one predetermined attribute, the method comprising:
(a) maintaining a count of ticket sales;
(b) detecting that a trigger condition is met, based on said count of ticket sales;
(c) obtaining a network address for each of a plurality of recipients having said at least one predetermined attribute;
(d) transmitting said promotional message for the entertainment event to each of said network addresses, wherein the promotional message comprises an offer;
(e) receiving an acceptance response to said offer from a responding recipient at at least one of said network addresses;
(f) processing said acceptance response by determining whether or not said offer is still available, according to said count of ticket sales, and:
(i) where said offer is not available, sending a denial message back to said responding recipient at said at least one of said network addresses; or,
(ii) where said offer is still open, updating said count of ticket sales and providing to said responding recipient at said at least one of said network addresses, a token to be presented for admission to the entertainment event according to said offer.

31. A method for broadcasting a promotional message for an entertainment event, said promotional message directed to recipients having a customer account card, the method comprising:
(a) obtaining a network address for each of a plurality of recipients having said customer account card;
(b) transmitting said promotional message for the entertainment event to each of said network addresses, wherein the promotional message comprises an offer;
(c) receiving an acceptance response to said offer from a responding recipient at at least one of said network addresses; and
(d) instructing said responding recipient at said at least one of said network addresses to present the customer account card for admission to the entertainment event according to said offer.

32. A method for broadcasting a promotional message according to claim 31 further comprising the step of executing a transaction on an account maintained according to the customer account card.

33. A method for broadcasting a promotional message for an entertainment event according to claim 31 wherein presenting said customer account card comprises the step of scanning said customer account card.
